(19) United States
(12) Patent Application Publication
(10) Pub. No.: US 2014/0290910 A1
(43) Pub. Date: Oct. 2, 2014

(54) INTAKE AIR COOLING SYSTEM

(71) Applicant: MITSUBISHI HITACHI POWER SYSTEMS, LTD., Yokohama-shi (JP)

(72) Inventors: Keita Fujii, Tokyo (JP); Kohei Hidaka, Tokyo (JP); Jiro Asakuno, Tokyo (JP); Masaru Takamatsu, Tokyo (JP); Tadakuni Nishio, Tokyo (JP); Tatsunao Nagashima, Tokyo (JP); Katsuhiro Hotta, Tokyo (JP); Masashi Nishimura, Tokyo (JP)

(73) Assignee: MITSUBISHI HITACHI POWER SYSTEMS, LTD., Yokohama-shi (JP)

(21) Appl. No.: 14/218,417

(22) Filed: Mar. 18, 2014

(30) Foreign Application Priority Data
Mar. 27, 2013 (JP) 2013-066830

(51) Int. Cl. F02C 7/18

(52) U.S. Cl. CPC F02C 7/185
USPC 165/96; 165/104.14

(57) ABSTRACT

An intake air cooling system 100 for a gas turbine 18 is provided with: an intake duct 12 for leading intake air taken in from an intake-air inlet 22 to a compressor 14 of the gas turbine 18; a cooling part 26 provided in the intake duct to cool the intake air by heat exchange with a cooling medium introduced from an outside; a drain discharge line 102 connected to a part of the intake duct below an inlet 14a of the compressor so as to discharge drain water flowing along an inner peripheral surface of the intake duct; and a water seal part 104 provided in the drain discharge line 102 to keep water seal in a part of the drain discharge line 102 by a water pressure at least corresponding to an amount of a negative pressure in the vicinity of the inlet of the compressor.

### TECHNICAL FIELD

The present invention relates to an intake air cooling system for cooling intake air of a gas turbine.

### BACKGROUND ART

In a gas turbine for power generation which is configured by a compressor, a combustor, a turbine, etc., the temperature of air taken into the compressor affects output of the turbine. For instance, in summer season when the atmospheric temperature is high, density of the intake air decreases and thus a mass flow rate decreases, hence the output of the turbine decreases. To suppress this sort of decrease in output of the turbine, intake air cooling systems have been developed, including an intake air cooling system equipped with a cooling coil for lowering the temperature of air taken in from outside by heat exchange with cooling medium, and an intake air cooling system which sprays water to the intake air to cool the intake air using heat of vaporization of the sprayed water. With the intake air cooling system equipped with the cooling coil, moisture in the atmosphere is cooled by heat exchange with the cooling coil and condensed into drain water. The drain water is then collected by a drain pan arranged below the cooling coil and is discharged from a drain pipe.

In the case where this intake air cooling system is used, however, the drain water adhering to a surface of the cooling coil may scatter to a downstream side along with the intake air passing through the cooling coil, or the drain water may fail to be collected by the drain pan and leak from the drain pan. Therefore, there are issues such as damage to blades of the compressor caused by erosion or lock of the compressor due to entry of the drain water into the compressor disposed on the intake side of the gas turbine. As a conventional technique for preventing the drain water from entering the compressor of the gas turbine, Patent Reference 1 discloses an intake air cooling device for a gas turbine, in which a mist removing means is provided on a downstream side of the intake duct of a vaporizer so as to remove mist from the intake air by collecting unvaporized mist. Further, Patent Reference 2 discloses a gas turbine which is provided with grooves that are formed in rotation symmetry in an inner wall surface of a flow passage, where operating air supplied with water flows, or in a rotor or a casing flow passage surface of the gas turbine, so as to collect mist adhering to the inner wall surface or the flow passage surface.

### CITATION LIST

### Patent Reference

### [Patent Reference 1]

### JP 2007-120479 A

### [Patent Reference 2]

### JP 2006-037877 A

### SUMMARY

### Technical Problem

As an intake duct for introducing intake air to a compressor, there is an intake duct having a manifold part with a reduced diameter on an inlet side of the compressor, compared to a diameter of an outside-air introduction part of the compressor, so as to straighten the intake air introduced to the compressor, thereby suppressing pressure loss and also suppressing performance decline of the compressor. The manifold part is, for instance, configured to extend downward in a height direction with respect to an installation surface of a cooling coil via a vertical duct extending in a curved manner downward in a direction perpendicular to a horizontal duct where the cooling coil is arranged in the intake duct.

In the case where the intake air is cooled using the intake air cooling system equipped with the above intake duct, there is a concern that the drain water generated by condensation of moisture on the surface of the cooling coil during supercooling or the like is scattered to the downstream side to reach the manifold part disposed on an inlet side of the gas turbine and accumulates there. When the accumulated drain water exceeds the limit, the drain water enters the compressor of the gas turbine, and this may cause lock or breakdown of the compressor, damage to compressor blades, etc. The above mentioned Patent Reference 1 and Patent Reference 2 refer to collecting the drain water passing through the intake duct or the drain water adhering to the wall surface of the intake duct, but there is no description regarding a measure to drain the drain water accumulated in the manifold part of the intake duct.

The present invention has been made in view of the above issues and is intended to provide a new and improved intake air cooling system which is capable of preventing drain water which has reached a manifold part of an intake duct from entering a compressor.

### Solution to Problem

One aspect of the present invention is an intake air cooling system for a gas turbine. The intake air cooling system comprises:

an intake duct configured to lead intake air taken in from an intake-air inlet to a compressor of the gas turbine;

a cooling part provided in the intake duct and configured to cool the intake air by heat exchange with a cooling medium which is introduced from an outside;

a drain discharge line connected to a part of the intake duct below an inlet of the compressor, the drain discharge line being configured to discharge drain water flowing along an inner peripheral surface of the intake duct; and

a water seal part provided in the drain discharge line and configured to keep water seal in a part of the drain discharge line by a water pressure at least corresponding to an amount of a negative pressure in a vicinity of the inlet of the compressor.

According to the above aspect of the present invention, by providing the water seal part, the drain discharge line can be sealed by the water pressure at least corresponding to the amount of the negative pressure in the vicinity of the inlet of the compressor of the gas turbine. Therefore, when the drain water reaches the drain discharge line, the drain water can be discharged to the outside of the intake duct.

In such case, in one aspect of the present invention, the intake duct may have a manifold part on a downstream side of the cooling part which is configured to lead the intake air to the compressor, and the drain discharge line may be connected to a bottom side of the manifold part so as to discharge the drain water accumulated in the manifold part.

Thus, when the drain water is accumulated in the manifold part, the drain water can be discharged to the outside of the manifold part by the drain discharge line.

In such case, in one aspect of the present invention, the water seal part may comprise a U-shaped pipeline which is constituted of two vertical pipes and a curved pipe connecting bottoms of the two vertical pipes, and the U-shaped pipeline may be filled with water such that a water level of one of the vertical pipes disposed on a manifold part side is higher than a water level of the other of the vertical pipes by at least the amount of the negative pressure.

By sealing the drain discharge line by the water pressure corresponding to at least the amount of the negative pressure in the vicinity of the inlet of the compressor, the drain water can be discharged to the outside of the manifold part by the drain discharge line when the drain water is accumulated in the manifold part.

Further, in one aspect of the present invention, a valve may be provided in the drain discharge line between the bottom side of the manifold part and the U-shaped pipeline so as to open and close the drain discharge line, the valve being normally open during operation of the compressor.

Thus, the valve is used during maintenance such as cleaning and repair of the compressor so that the maintenance can be performed appropriately.

### Advantageous Effects

According to the above described invention, it is possible to discharge the drain water having reached the manifold part of the intake duct to the outside of the manifold part so that the drain water is prevented from entering the compressor.

### BRIEF DESCRIPTION OF DRAWINGS

FIG. 1 is a block diagram showing a configuration of a gas turbine plant equipped with an intake air cooling system according to one embodiment of the present invention.

FIG. 2 is a schematic configuration diagram of a drain discharge line provided in the intake air cooling system according to one embodiment of the present invention.

### DETAILED DESCRIPTION

An embodiment of the present invention will now be described in detail with reference to the accompanying drawings. It is intended, however, that unless particularly specified, dimensions, materials, shapes, relative positions and the like of components described in the embodiment shall be interpreted as illustrative only and not limitative of the scope of the present invention.

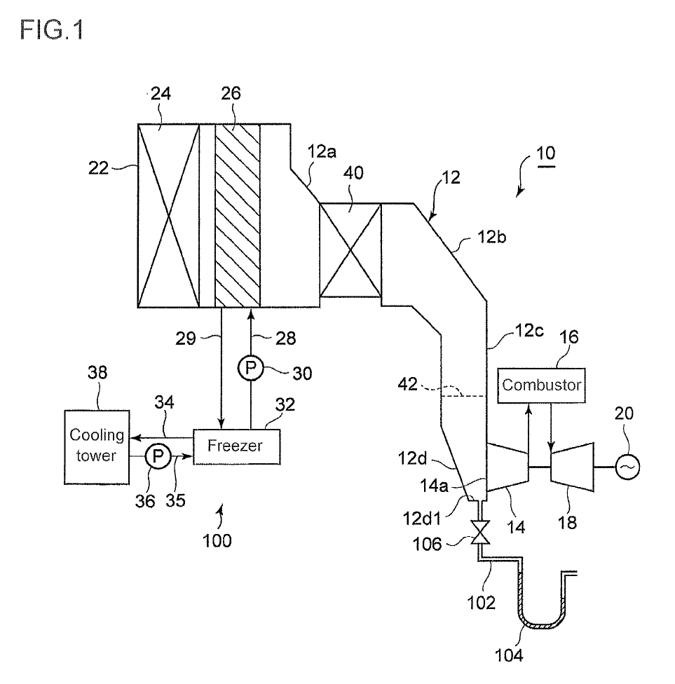

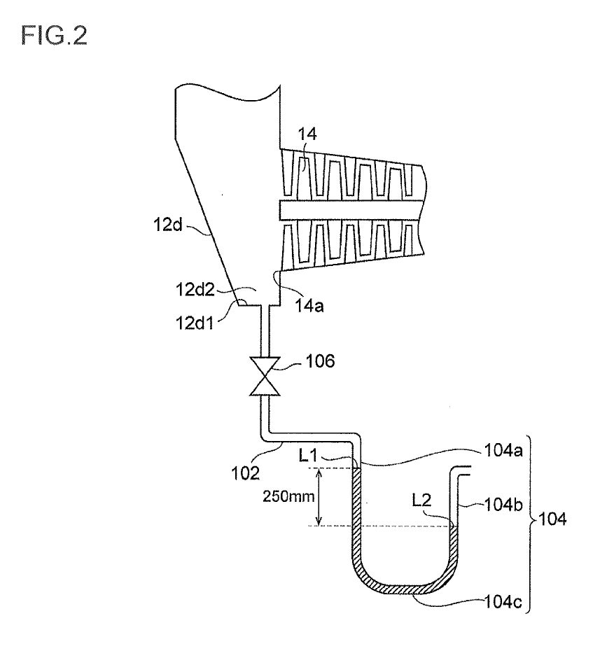

The configuration of the intake air cooling system according to one embodiment of the present invention is described in reference to the accompanying drawings. FIG. 1 is a block diagram showing a configuration of a gas turbine plant equipped with the intake air cooling system according to one embodiment of the present invention. FIG. 2 is a schematic configuration diagram of a drain discharge line provided in the intake air cooling system according to one embodiment of the present invention.

A gas turbine plant 10 serving as a power generation plant comprises an intake duct 12, a compressor 14, a combustor 16, a gas turbine 18 and a generator 20. Further, an intake air cooling system 100 is provided in the gas turbine plant 10 to cool intake air of the gas turbine 18. In this embodiment, the intake air cooling system 100 comprises at least the intake duct 12, a cooling coil 26 (a cooling part), a chiller 32, a cooling tower 38, a drain discharge line 102 and a water seal part 104. As another embodiment, the intake air cooling system 100 may be configured to spray water to intake air so as to cool the intake air by vaporization heat of the water.

The intake duct 12 is configured to lead the intake air (outside air: air) taken in from an intake-air inlet 22 to the compressor 14. The compressor 14 is configured to compress the intake air supplied via the intake duct 12. The combustor 16 is configured to combust fuel using the intake air supplied from the compressor 14. The gas turbine 18 is configured to be rotated by combustion gas supplied from the combustor 16. The generator 20 is configured to generate power by rotation of the gas turbine 18.

The intake duct 12 comprises, as illustrated in FIG. 1, a horizontal duct 12a, a curved duct 12b, and a vertical duct 12c in this order from an upstream side to a downstream side. On a downstream side of the vertical duct 12c, a manifold part 12d is provided for leading and straightening the intake air to the compressor 14. In this embodiment, the manifold part 12d is configured to extend downward via the vertical duct 12c curving downward in a direction perpendicular to the horizontal duct 12a.

On the inlet side of the intake duct 12, a prefilter 24 is provided to remove relatively large particles of dust or the like from the intake air taken in from the intake-air inlet 22. Further, on a downstream side of the prefilter 24 in the intake duct 12 (the horizontal duct 12a), the cooling coil 26 is provided to cool the intake air exiting the prefilter 24 by heat exchange with a cooling medium introduced from an outside. Under the cooling coil 26, a drain pan (not shown) is provided to collect drain water condensed by cooling of the intake air by heat exchange with the cooling coil 26. The drain water collected by the drain pan is discharged to the outside of the intake duct 12 from a drain pipe (not shown).

Cold circulation water (cooling medium) is supplied to the cooling coil 26 from the chiller 32, such as an absorption chiller or a centrifugal chiller, via a first circulation path 28 and a first circulation pump 30. The circulation water is heated by heat exchange with the intake air in the cooling coil 26 and then returned to the chiller 32 via the first circulation path 29. Cold circulation water is supplied to the chiller 32 from the cooling tower 38 via second circulation paths 34, 35 and a second circulation pump 36. The circulation water is used in the chiller 32 to perform heat exchange with the circulation water circulating in the first circulation paths 28, 29 and then returned to the cooling tower 38 via the second circulation path 34 to be cooled again in the cooling tower 38.

A silencer 40 is provided in the horizontal duct 12a of the intake duct 12 on the downstream side of the cooling coil 26, so as to suppress vibration including noise generated when taking in the air. A filter 42 is provided on the inlet side of the manifold part 12d connected to the vertical duct 12c of the intake duct 12. The filter 42 is configured to remove impurities contained in the intake air introduced via the vertical duct 12c and screws, etc. which have fallen when performing work or the like in the intake duct.

The intake air cooling system 100 serves to collect drain water generated from cooling of the intake air by heat exchange at the cooling coil 26 so as to prevent the drain water from entering the compressor 14. For this function, the drain discharge line 102 is provided below an inlet 14a of the compressor 14, and one end of the drain discharge line 102 is connected to a part of the intake duct 12 below an inlet 14a of the compressor 14. In this embodiment, the drain discharge line 102 is connected to a bottom of the intake duct 12 immediately below the inlet 14a of the compressor 14. When the drain water generated on the surface of the cooling coil 26 reaches the manifold part 12d due to scatter, etc. toward the downstream side along the inner peripheral surface of the intake duct 12, this drain water is collected and discharged by the drain discharge line 102. A U-shaped pipeline 104 is provided midway in the drain discharge line 102. The U-shaped pipeline 104 serves as a water seal part for keeping water seal in a part of the drain discharge line 102 by a water pressure at least corresponding to an amount of a negative pressure in a vicinity of the inlet 14a of the compressor 14.

Further, a valve 106 is provided in the drain discharge line 102 between a bottom part 12d1 of the manifold part 12d and the U-shaped pipeline 104 so as to open and close the drain discharge line 102. This valve 106 is configured to be normally open during operation of the compressor 14 except during maintenance such as cleaning and repair of the compressor 14. Specifically, the valve 106 is normally kept open so that the drain water accumulated in the manifold part 12d is discharged by the drain discharge line 102, whereas the valve 106 is closed during maintenance such as cleaning and repair of the compressor 14 so that the maintenance is performed appropriately.

The drain discharge line 102 is, as illustrated in FIG. 2, connected to the bottom side of the manifold part 12d disposed immediately below the inlet 14a of the compressor 14 to discharge the drain water accumulated in the manifold part 12d. Specifically, the drain discharge line 102 has a function to discharge the drain water to the outside of the manifold part 12d when the drain water is accumulated in the manifold part 12d. In this embodiment, a water seal part 104 is provided midway in the drain discharge line 102 to discharge the drain water to the outside of the manifold part 12d when the drain water is accumulated in the manifold part 12d. The water seal part 104 is configured to keep water seal by a water pressure corresponding to at least an amount of the negative pressure in the vicinity of the inlet 14a of the compressor 14.

In this embodiment, the water seal part 104 comprises the U-shaped pipeline 104 which is constituted of two vertical pipes 104a, 104b and a curved pipe 104c connecting bottoms of the two vertical pipes 104a, 104b. The U-shaped pipeline 104 is filled with water such that a water level L1 of one of the vertical pipes 104a disposed on a manifold part side is higher than a water level L2 of the other of the vertical pipes 104b by at least the amount of the negative pressure in the vicinity of the inlet 14a of the compressor 14. More specifically, a negative pressure of approximately 250 mm H₂O is applied on the vicinity of the inlet 14a of the compressor 14 during operation of the compressor 14. Thus, in order to seal the drain discharge line 102 by the water pressure, the U-shaped pipeline 104 is filled with water in such a manner that the water level L1 of the vertical pipe 104a is higher than the water level L2 of the vertical pipe 104b by at least 250 mm to achieve a pressure balance.

When the compressor 14 of the gas turbine plant 10 is operated, the negative pressure of approximately 250 mm H₂O is applied on the inlet 14a of the compressor 14. Therefore, by filling the U-shaped pipeline 104 with water in such a manner that the water level L1 of the vertical pipe 104a is higher than the water level L2 of the vertical pipe 104b by at least 250 mm, the drain discharge line 102 can be sealed by the pressure balance between the vertical pipes 104a, 104b even when the valve 106 is kept normally open.

As described above, the drain discharge line 102 and the water seal part 104 are provided in this embodiment. Therefore, as the valve 106 of the drain discharge line 102 is kept open, the drain water accumulated in the manifold part 12d flows into the drain discharge line 102. Then, the pressure balance is lost between the vertical pipes 104a, 104b of the U-shaped pipeline 104, and hence the drain water flows from the vertical pipe 104a on the manifold part 12d side to the other vertical pipe 104b to be discharged to the outside of the manifold part 12d.

Specifically, the drain discharge line 102 is connected to the bottom side 12d1 of the manifold part 12d, so as to discharge the drain water to the outside of the manifold part 12d in the case where the drain water generated at the cooling coil 26 scatters and reaches the manifold part 12d. Thus, it is possible to prevent the drain water accumulated in the manifold part 12d from entering the compressor 14, and hence to suppress breakage and damage of the compressor 14 caused by the drain water.

Especially, the bottom side 12d1 of the manifold part 12d protrudes downward past the inlet 14a of the compressor 14 to straighten and lead the intake air uniformly to the compressor 14, and the bottom side 12d1 defines a space 12d2 inside the manifold part 12d, which is disposed immediately below the inlet 14a of the compressor 14. The space 12d2 of the manifold part 12 serves as a drain reservoir to facilitate accumulation of the drain water. Therefore, in this embodiment, the drain discharge line 102 connected to the bottom side 12d1 of the manifold part 12d is provided so as to enable constant draining. As a result, it is possible to prevent breakdown of the compressor 14 caused by the drain water entering the compressor 14.

Further, the drain water is possibly generated after the cooling coil 26 is turned off and the intake air which is not cooled by the cooling coil 26 generates dew condensation on the cold inner wall surface of the intake duct 12 (12a, 12b, 12c). Therefore, the drain water generated on the inner wall surface of the intake duct 12 moves along the intake duct 12 and reaches a part of the manifold part 12d below the inlet 14a of the compressor 14. This drain water needs to be discharged to the outside of the intake duct 12. In this embodiment, the drain discharge line 102 is connected to the bottom side 12d1 of the manifold part 12d to discharge this drain water.

When water leakage occurs due to breakage, etc. of the cooling coil 26, this leaked water reaches the manifold part 12d. Thus, by providing the drain discharge line 102, it is also possible to detect occurrence of abnormality such as breakage of the cooling coil 26. Specifically, when abnormality occurs, such as breakage of the cooling coil 26, the cooling medium leaks from the cooling coil 26 and flows in the intake duct 12 to reach the manifold part 12d. In such case, the water flows into the drain discharge line 102 more powerfully than during the normal operation. Therefore, the drain discharge line 102 can also be utilized to detect occurrence of abnormality in the cooling coil 26.

Furthermore, in this embodiment, the negative pressure of approximately 250 mm H₂O is applied on the inlet 14a of the compressor 14 to keep water seal such that the water level L1 of the vertical pipe 104a is higher than the water level L2 of the vertical pipe 104b by at least 250 mm. The water level difference is not limited to 250 mm. Specifically, the water level difference between those two water levels of the U-shaped pipeline 104 is adjustable according to the amount of the negative pressure in the vicinity of the inlet 14a of the compressor 14 to obtain the pressure balance and keep water seal, by arbitrarily adjusting the amount of water filling the U-shaped pipeline 104.

As described above, in this embodiment, the drain discharge line 102 is connected to the bottom side 12d1 of the manifold part 12d disposed immediately below the inlet 14a of the compressor 14, so as to discharge the drain water accumulated in the manifold part 12d serving as the drain reservoir. Further, the U-shaped pipeline 104 serving as the water seal part is provided in the drain discharge line 102, and the valve 106 disposed between the manifold part 12d and the U-shaped pipe 104 is kept open during operation of the compressor 14. Therefore, the drain water which is easily accumulated in the manifold part 12d along the intake duct 12 can be always discharged and thus, it is possible to prevent breakdown, etc. of the compressor 14 caused by entry of the drain water into the compressor 14.

While the embodiment of the present invention has been described, it is obvious to those skilled in the art that various changes and modifications may be made without materially departing from the novel teachings and advantages of this invention. Accordingly, all such modifications are intended to be included within the scope of this invention.

Any term cited with a different term having a broader meaning or the same meaning at least once in the specification or the drawings can be replaced by the different term in any place in the specification or the drawings. The configuration and the operation of the intake air cooling system for the gas turbine or the gas turbine plant are not limited to those described in connection with the above embodiment, and various modifications and variations may be made.

### REFERENCE SIGNS LIST

10 Gas turbine plant
12 Intake duct
12a Horizontal duct
12b Curved duct
12c Vertical duct
12d Manifold part
12d1 Bottom side (of the manifold part)
14 Compressor
14a Inlet (of the compressor)
16 Combustor
18 Gas turbine
20 Generator
22 Intake-air inlet
24 Prefilter
26 Cooling coil (Cooling part)
28, 29 First circulation path
30 First circulation pump
32 Chiller
34, 35 Second circulation path
36 Second circulation pump
38 Cooling tower
40 Silencer
42 Filter
100 Intake air cooling system
102 Drain discharge line
104 U-shaped pipeline (Water seal part)
104a, 104b Vertical pipe
104c Curved pipe
106 Valve

1. An intake air cooling system for a gas turbine, the system comprising:
an intake duct configured to lead intake air taken in from an intake-air inlet to a compressor of the gas turbine;
a cooling part provided in the intake duct and configured to cool the intake air by heat exchange with a cooling medium which is introduced from an outside;
a drain discharge line connected to a part of the intake duct below an inlet of the compressor, the drain discharge line being configured to discharge drain water flowing along an inner peripheral surface of the intake duct; and
a water seal part provided in the drain discharge line and configured to keep water seal in a part of the drain discharge line by a water pressure at least corresponding to an amount of a negative pressure in a vicinity of the inlet of the compressor.

2. The intake air cooling system according to claim 1,
wherein the intake duct has a manifold part on a downstream side of the cooling part which is configured to lead the intake air to the compressor, and
wherein the drain discharge line is connected to a bottom side of the manifold part so as to discharge the drain water accumulated in the manifold part.

3. The intake air cooling system according to claim 2,
wherein the water seal part comprises a U-shaped pipeline which is constituted of two vertical pipes and a curved pipe connecting bottoms of the two vertical pipes, and
wherein the U-shaped pipeline is filled with water such that a water level of one of the vertical pipes disposed on a manifold part side is higher than a water level of the other of the vertical pipes by at least the amount of the negative pressure.

4. The intake air cooling system according to claim 3,
wherein a valve is provided in the drain discharge line between the bottom side of the manifold part and the U-shaped pipeline so as to open and close the drain discharge line, the valve being normally open during operation of the compressor.
